(19) United States
(12) Patent Application Publication
(10) Pub. No.: US 2009/0112987 A1
(43) Pub. Date: Apr. 30, 2009

(54) Method and system for establishing commonality between members in an online community

(76) Inventor: Sunil Bhargava, Hillsborough, CA (US)

Correspondence Address: LESTER H. BIRNBAUM, 6 OAKMOUNT COURT, SIMPSONVILLE, SC, 29681, US

(21) Appl. No.: 11/978,413

(22) Filed: Oct. 29, 2007

(51) Int. Cl. G06F 15/16

(52) U.S. Cl. 709/204

(57) ABSTRACT

A method, system and computer program product for establishing commonality between a plurality of members and deriving an opinion of a dignitary on one or more issues in an online community is disclosed. A questioner poses a questionnaire, which includes one or more questions on the issues in the online community. The method includes receiving one or more responses to the questions from the members. The responses are processed to derive the attributes of each of the members. A commonality indicator indicating a commonality between the members is derived based on the attributes of the members. Further, a normalcy indicator between a member and the plurality of members is derived. Further, the opinion of the dignitary is derived based on the responses of the plurality of members.

### BACKGROUND

The present invention relates in general to an online community. More specifically, the present invention relates to a method and system for establishing commonality between members in an online community.

An online community is a group of members that communicate with each other through a communication network. Examples of communication networks may include a Local Area Network (LAN), a Metropolitan Area Network (MAN), a Wide Area Network (WAN), including the Internet, and the like. A member of the online community may pose a set of questions on an issue. Other members of the online community may provide their view points and comments on the issue. Exemplary issues may include issues related to social reforms, politics, economics, information technology, entertainment, and the like.

Various methods are available for establishing commonality between the members on an issue in an online community. One such method is using an online compatibility test such as that available on Flixster.com. In this method, a set of members of the online community undertake a Movie Compatibility Test (MCT). MCT requires the members to rate 50 carefully chosen movies and award a rating to each of them. A commonality, such as bad, good, and exact, is provided between the members based on the MCT ratings. The members can also discuss various movies, videos, and actors-related topics in the online community. However, the commonality between the members is derived based on their interests pertaining only to movies and not on any other issue that may be of interest to them. Further, the online community does not allow the members to establish a correlation between their attributes and the cumulative attibutes of the members of the online community. The correlation between the attributes of a member and the cumulative attributes of the members of the online community is referred to as normalcy of the member with respect to the online community.

Another method for establishing commonality between the members is using a questionnaire mechanism in an online community, such as that implemented on OnThelssues.com. In this method, information is collected from various sources, such as newspapers and press releases, related to the opinions of various political leaders on an issue. This information is used to prepare a questionnaire on the issue that is answered by various members of the online community. Commonality of the members with the various political leaders is established, based on their answers to the questions. However, the method does not allow the members to derive the opinion of a political leader on the issue.

In light of the above discussion, there is a need for a method, system and computer program product for establishing commonality between the members of an online community on the basis of various issues related to different aspects. Moreover, the method should allow a member to establish a correlation between their attributes and cumulative attributes of the members of the online community. Further, the method should allow the members to derive an opinion of a dignitary, such as a political leader, based on an aggregate opinion of the dignitary, as supposed by the members of the online community.

### SUMMARY

An objective of the present invention is to provide a method for establishing commonality between at least two members of an online community.

Another objective of the present invention is to enable a member to establish its normalcy with respect to the plurality of members of the online community.

Still another objective of the present invention is to enable a member to search and communicate with other members based on a specified commonality criterion.

Yet another objective of the present invention is to enable a plurality of members to derive an opinion of a dignitary on one or more issues.

In order to achieve the above-mentioned objectives, the present invention provides a method, system and computer program product for establishing commonality between at least two of a plurality of members on the basis of one or more issues in the online community.

The online community includes the plurality of members connected through a communication network. A questioner poses a questionnaire, which includes one or more questions on the one or more issues in the online community. In an embodiment of the present invention, the questioner may associate a plurality of predefined options with each of the questions.

Each of the plurality of members selects its responses from the plurality of predefined options. Further, the plurality of members may provide one or more comments to elaborate their responses to each of the questions. The responses of each of the plurality of members are processed to derive one or more attributes associated with each of the plurality of members. Further, a commonality indicator may be derived between at least two of the plurality of members based on their attributes. Furthermore, the present invention derives a normalcy indicator of one of the plurality of members with respect to the plurality of members of the online community.

The present invention provides a method that enables the plurality of members to search and communicate with each other based on a specified criterion. Furthermore, the plurality of members may initiate debates and discussions on various issues in the online community.

In an embodiment of the present invention, the plurality of members may provide the responses on behalf of a dignitary. An opinion of the dignitary may be derived, based on an aggregate opinion of the dignitary, as supposed by the members of the online community.

### BRIEF DESCRIPTION OF THE DRAWINGS

Various embodiments of the present invention will hereinafter be described in conjunction with the appended drawings provided to illustrate and not to limit the present invention, wherein like designations denote like elements, and in which:

FIG. 1 depicts an online community in which various embodiments of the present invention may be practised;

FIG. 2 depicts a block diagram of an online community for establishing commonality between at least two members on one or more issues, in accordance with an embodiment of the present invention;

FIG. 3 depicts a block diagram of an online community for deriving an opinion of a dignitary on one or more issues, in accordance with an embodiment of the present invention;

FIG. 4 depicts a flowchart of a method for establishing commonality between at least two members on one or more issues in an online community, in accordance with an embodiment of the present invention; and

FIG. 5 depicts a flowchart of a method for deriving an opinion of a dignitary on one or more issues in an online community, in accordance with an embodiment of the present invention.

### DETAILED DESCRIPTION OF THE INVENTION

The present invention provides a method, system and computer program product for establishing commonality between at least two of a plurality of members on one or more issues in an online community. The members of the online community answer a questionnaire associated with the issues. The responses of the members are processed to derive one or more attributes of the members. Further, a commonality indicator is derived between at least two of the plurality of members based on their responses and attributes. The responses and attributes of a member may further be used to derive its normalcy indicator with respect to the plurality of members.

The present invention further provides a method and system for deriving an opinion of a dignitary on one or more issues. The members answer a questionnaire and associate the responses with the dignitary. The opinion of the dignitary on one or more issues is derived based on these responses.

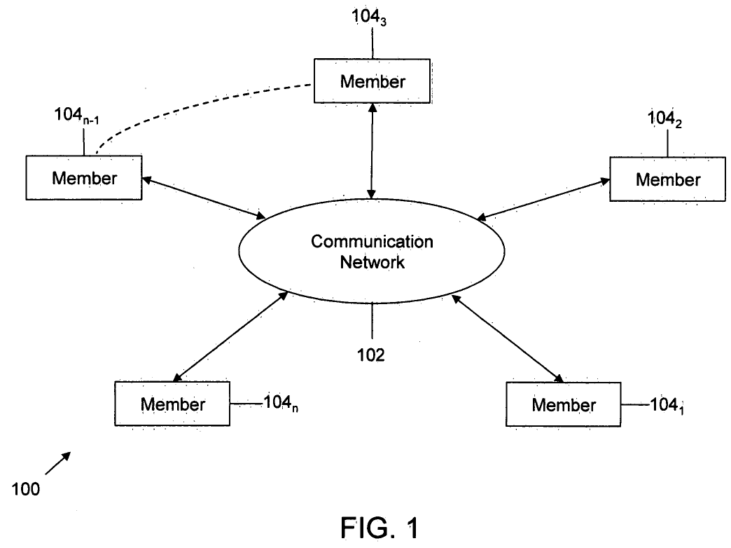

FIG. 1 depicts an online community 100 in which various embodiments of the present invention may be practised. Online community 100 includes a plurality of members such as a member 104₁, a member 104₂, a member 104₃, up to a member 104ₙ₋₁ and a member 104ₙ connected through a communication network 102. The plurality of members, member 104₁, member 104₂, member 104₃, up to a member 104ₙ₋₁ and a member 104ₙ, is hereinafter referred to as members 104. Members 104 communicate with each other through communication network 102.

In an embodiment of the present invention, online community 100 may be a blog, a message board or a newsgroup where members 104 may share their views with other members.

In various embodiments of the present invention, communication network 102 may be a wired or a wireless network. Examples of communication network 102 include, but are not limited to, a Local Area Network (LAN), a Metropolitan Area Network (MAN), a Virtual Private Network (VPN), a Wide Area Network (WAN), including the internet and the like.

Each member 104 has a member profile associated with it. In an embodiment of the present invention, members 104 provide such information as personal information, identification information, professional information, and contact information at the time of registration with online community 100. This information is included in the member profile of member 104.

The personal information may include, but is not limited to, name, age, gender, marital status, interests and hobbies. The identification information may include, but is not limited to, a unique login name and password, and personal identification numbers such as a driving license number and a passport number. The professional information may include details of educational qualification, occupation, university's or company's name, work experience, and the like. The contact information may include the residential address, office address, phone numbers, e-mail addresses, and Instant Message (IM) handles.

In various embodiments of the present invention, members 104 form one or more groups based on the registration details included in the member profile.

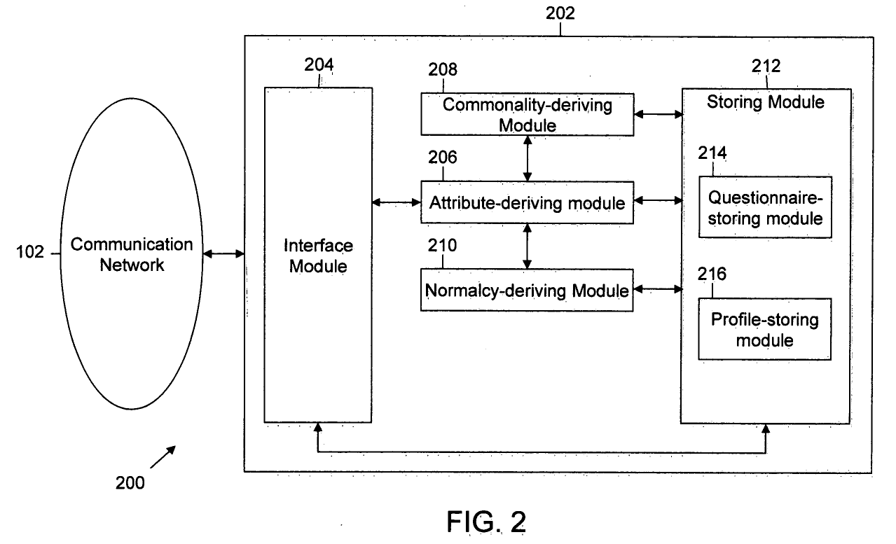

FIG. 2 depicts a block diagram of an online community 200 for establishing commonality between at least two members 104 on one or more issues, in accordance with an embodiment of the present invention. Online community 200 includes members 104, connected through communication network 102, and a system 202. System 202 includes an interface module 204, an attribute-deriving module 206, a commonality-deriving module 208, a normalcy-deriving module 210, and a storing module 212.

In online community 200, at least one of members 104, hereinafter referred to as the questioner, poses a questionnaire which includes one or more questions on one or more issues. The questioner provides a plurality of predefined options, hereinafter referred to as the predefined options, with each question of the questionnaire. In various embodiments of the present invention, the predefined options may be based on various possible responses that members 104 may have on the issues. In an embodiment of the present invention, the questioner associates a plurality of predefined comments, hereinafter referred to as the predefined comments, with each of the predefined options.

Interface module 204 prompts members 104 to answer the questionnaire. One or more members 104, hereinafter referred to as the participating members, answer the questionnaire and provide their responses by selecting one of the predefined options associated with a question. Further, the participating members may select one of the predefined comments associated with the predefined options. In an embodiment of the present invention, the participating members may provide a member-defined comment through a text-input field provided by interface module 204. The response to a question, as used herein, unless expressly stated otherwise, is meant to include a selected option, a selected comment, or a member-defined comment, as the case may be.

For example, to establish commonality between members 104 on an issue, such as ‘Natural Resources’, a questioner poses a question, such as ‘What is the preferred alternative for replacing coal and oil?’ in online community 200. The questioner associates the predefined options with the question, such as ‘replace with solar energy’, ‘replace with wind energy’, ‘replace with wave energy’, ‘replace with nuclear energy’, ‘no need to replace’, and ‘do not know’. Member 104₁ answers the questionnaire and selects ‘replace with solar energy’ from the predefined options. Further, the predefined comments associated with the option ‘replace with solar energy’ include ‘to prevent depletion of coal and oil reserves’ and ‘to check environmental problems’. Member 104₁ may select the comment, such as ‘to prevent depletion of coal and oil reserves’, for elaborating the selected option.

Interface module 204 receives the responses of the participating members and provides the information to attribute-deriving module 206.

Attribute-deriving module 206 processes the responses to derive one or more attributes of each of the participating members. For example, processing of the option ‘replace with solar energy’ and comment ‘depletion of coal and oil’ derives attribute ‘aware of economic and environmental problems’ for member 104₁. Such attributes are included in the member profile of the participating member.

As explained in conjunction with FIG. 1, members 104 may form one or more groups based on the registration details included in the member profile. Similarly, members 104 may form one or more groups based on the attributes of members 104 derived through the questionnaires on various issues and included in the member profiles.

In an embodiment of the present invention, attribute-deriving module 206 derives one or more attributes associated with the one or more groups based on the responses of the participating members of the respective groups. For example, members 104 form a group of members residing in California and termed as ‘Californians’. If a majority of the options and comments selected by the members of ‘Californians’ are ‘replace with solar energy’ and ‘to prevent depletion of coal and oil reserves’ respectively, the attributes derived by attribute-deriving module 206 for the group ‘Californians’ may be ‘aware of economic and environmental problems’ and ‘favors alternate energy sources to conserve natural resources’.

Commonality-deriving module 208 derives a commonality indicator between at least two of the participating members based on at least one of their responses to the questionnaire and the attributes derived by the attribute-deriving module 206 as included in the member profiles. The commonality indicator may be in the form of a quantitative value, such as a numerical value and a percentage value, or a qualitative value, such as ‘low’, ‘average’, ‘high’, and ‘excellent’.

In an embodiment of the present invention, commonality indicator between at least two of the participating members is derived based on the responses to each of the one or more questions on the issue. For example, based on their responses to a questionnaire, member 104₁ and member 1042 may have a commonality indicator of 85 percent or ‘high’ with respect to the issue ‘environment’, if 85 percent of their responses on the issue ‘environment’ are the same, and a commonality indicator of 50 percent or ‘average’ with respect to an issue ‘economy’, if 50 percent of their responses on the issue ‘economy’ are the same.

In another embodiment of the present invention, the questioner associates a score with each of the predefined options in the questionnaire. Commonality-deriving module 208 derives the commonality indicator between at least two of the participating members based on a comparison of their scores for each question in the questionnaire.

In another embodiment of the present invention, the commonality indicator between at least two of members 104 is derived based on the attributes of the members included in their member profiles. The attributes included in the member profiles are derived based on their responses to questionnaires on various issues answered during the term their memberships. For example, the member profiles of member 104₁ and member 104₂ include several attributes derived through responses to questionnaires on various issues answered by member 104₁ and member 104₂ during the term of their memberships. Commonality-deriving module 208 derives a commonality indicator between them based on the attributes derived with respect to various issues answered by both of them.

In an embodiment of the present invention, commonality-deriving module 208 derives the commonality indicator between at least two of the one or more groups of members 104.

Normalcy-deriving module 210 derives a normalcy indicator of a participating member with respect to the other participating members based on their responses on the one or more issues. Exemplary normalcy indicators may include, but are not limited to, a quantitative value, such as a numerical and a percentage value, or a qualitative value, such as ‘normal’ and ‘abnormal’.

In an embodiment of the present invention, the normalcy indicator of a participating member with respect to other participating members is derived based on the responses of the participating member and the other participating members to the one or more questions on the issue. For example, based on their responses to a questionnaire, member 104₁ may have a normalcy indicator of 85 percent or ‘high’ with respect to other participating members on the issue ‘environment’, if 85 percent of his responses on the issue ‘environment’ are the same as the majority response.

In another embodiment of the present invention, the questioner associates a score with each of the predefined options in the questionnaire. Normalcy-deriving module 208 derives the normalcy indicator of a participating member with respect to other participating members based on a comparison of their scores for each question in the questionnaire.

Further, normalcy-deriving module 210 derives the normalcy indicator of a member 104 with respect to a group of members 104.

The normalcy indicator of a member with respect to a group of members is derived based on the attributes of the member and the group of members included in their respective profiles. The attributes included in the member profiles are derived based on their responses to questionnaires on various issues answered during the term their memberships. For example, normalcy indicator of member 104₁ may be ‘normal’ with respect to the group ‘Californians’ based on the attributes of member 104₁ and the attributes of the group ‘Californians’ on the issue ‘environment’ as described above.

In an embodiment of the present invention, the questions, the predefined options, and the predefined comments may be modified based on various conditions, such as small numbers of responses, unclear comments, inability to derive commonality indicator between the participating members, and the like. For example, in case a greater number of responses such as ‘do not know’ are received in comparison with other options, the questioner modifies the questions or the predefined options to provide better options to the participating members.

In an embodiment of the present invention, if a participating member changes its response at a later time, the attributes are derived again and the member profile of the participating member is updated. For example, assume member 104₁ modifies the response from ‘replace with solar’ to ‘do not know’. The attributes associated with member 104, may be modified from ‘aware of economic and environmental problems’ to ‘uninformed’ by attribute-deriving module 206.

Storing module 212 includes a questionnaire-storing module 214 and a profile-storing module 216. Questionnaire-storing module 214 stores a set of questionnaires associated with the one or more issues. A questionnaire, as used herein, includes questions, corresponding predefined options, and corresponding predefined comments associated with the one or more issues. Profile-storing module 216 stores a member profile of each member 104. As described earlier in conjunction with FIG. 1, the member profile includes registration details. Further, the member profile may include the attributes derived on the basis of the responses to one or more questionnaires associated with the one or more issues, and other such information. Further, in an embodiment of the present invention, profile-storing module 216 includes profiles of each group of members 104.

In an embodiment of the present invention, online community 200 enables members 104 to search for issues, members and groups in online community 200. The search may be used to identify issues of interest and to identify those member profiles and group profiles that meet a specified criterion. The search may be based on combinations of various criteria, such as the information included in registration details, responses, attributes, commonality indicators, and normalcy indicators. Examples of criteria may include, but are not limited to, members residing in the same city, members selecting a specified option from the predefined options, members with a specified normalcy indicator with respect to a group, groups based on issues of interest, and the like.

In various embodiments of the present invention, a number of activities, such as contests and debates may be organized between members 104. For example, member 104₁ may initiate a discussion among the participating members with the response ‘replace with solar energy’ to a question on the issue of ‘environment’.

In an embodiment of the present invention, the questionnaire may be posed on an online community, such as a blog. The visitors to the blog provide their response to the questions included in the questionnaire. The questioner may pose the questionnaire on different communities having members with different backgrounds, such as geographical location, mother tongue, and profession. The questioner then compares and analyzes the responses of the members obtained from different communities based on the differences in the backgrounds.

In various embodiments of the present invention, different elements of system 202, such as interface module 204, attribute-deriving module 206, commonality-deriving module 208, normalcy-deriving module 210, and storing module 212 or a combination thereof may be implemented in the form of hardware, software, firmware, or a combination thereof. One or more of these modules may be present on the machine of one or more of members 104, or a dedicated computational device on communication network 102.

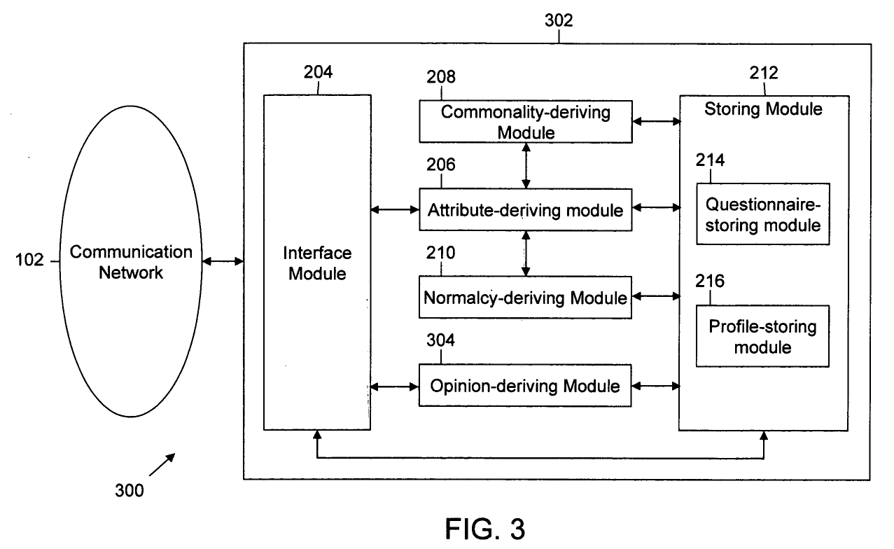

FIG. 3 depicts a block diagram of an online community 300 for deriving an opinion of a dignitary on one or more issues, in accordance with an embodiment of the present invention. Online community 300 includes members 104 connected through communication network 102, and a system 302. System 302 includes interface module 204, attribute-deriving module 206, commonality-deriving module 208, normalcy-deriving module 210, an opinion-deriving module 304, and storing module 212.

In online community 300, at least one of members 104, hereinafter referred to as the questioner, poses a questionnaire, which includes one or more questions, such as, ‘Should immigration be encouraged?’ on an issue such as ‘Immigration’. The questioner poses the questionnaire to derive the opinion of the dignitary on the issue based on an aggregate opinion of the dignitary, as supposed by members 104 of online community 300. Examples of a dignitary may include, but are not limited to, a political leader, an actor, a social worker, an entrepreneur, a sports person and a scientist. For example, the dignitaries may include Hillary Clinton, Tom Cruise and Pete Sampras.

The questioner provides a plurality of predefined options, hereinafter referred to as the predefined options, with each question of the questionnaire. The predefined options may be based on the various possible opinions that the dignitaries may have on the issues. For example, the questioner may associate options ‘support’, ‘no opinion’, and ‘oppose’, with the question.

In an embodiment of the present invention, a plurality of predefined comments, hereinafter referred to as the predefined comments, is associated with each of the predefined options.

Interface module 204 prompts members 104 to answer the questionnaire. One or more members 104, hereinafter referred to as the participating members, answer the questionnaire by selecting one of the predefined options associated with a question. The participating members select such option as they suppose to be the opinion of the dignitary based on their perception. Further, the participating members may select one of the predefined comments associated with the option. In an embodiment of the present invention, the participating members may provide a member-defined comment through a text-input field provided by interface module 204. The comments may include reasons for the selected option, insights on the issue, and the like, to support the selected option of the participating members.

For example, member 104₁ selects ‘support’ on behalf of Hillary Clinton and member 1042 selects ‘no opinion’ on behalf of Pete Sampras. Further, member 104₁ associates a comment, such as ‘contributes in growing economy’ with the option ‘support’.

The response to a question, as used herein, unless expressly stated otherwise, is meant to include a selected option, a selected comment, or a member-defined comment, as the case may be.

Interface module 204 receives the responses of the participating members and provides the information to attribute-deriving module 206.

Opinion-deriving module 304 derives the opinion of the dignitary, based on the responses of the participating members. The responses are processed to derive an aggregate opinion of the dignitary, as supposed by the participating members.

For example, if a majority of the responses corresponding to Hillary Clinton are ‘support’, the derived opinion of Hillary Clinton may be ‘supports immigration as it contributes in growing economy’. Similarly, the opinion of Tom Cruise and Pete Sampras is derived based on the responses of the participating members corresponding to Tom Cruise and Pete Sampras respectively.

In an embodiment of the present invention, the questions, the predefined options, and the predefined comments may be modified based on various conditions. For example, the questioner modifies the questions if system 302 is unable to derive an opinion of the dignitaries based on the responses received.

In an embodiment of the present invention, if a participating member changes its response at a later time, the response is processed and the opinion of the dignitary may be modified based on the changes in the response of the participating member.

Storing module 212 includes questionnaire-storing module 214 and profile-storing module 216. Questionnaire-storing module 214 stores a set of questionnaires associated with the one or more issues. A questionnaire, as used herein, includes questions, predefined options, and predefined comments associated with the one or more issues. Profile-storing module 216 stores a member profile of each member 104. As described earlier, the member profile includes registration details, the attributes derived on the basis of the responses to one or more questionnaires associated with the one or more issues, and other such information. Further, in an embodiment of the present invention, profile-storing module 216 includes profiles of each group of members 104. Further, profile-storing module 216 includes profiles of the dignitaries, which may or may not be a member of online community 300. The profiles of the dignitaries include their opinions on one or more issues as derived in online community 300.

In an embodiment of the present invention, the participating members compare their responses with the opinion of the dignitary on one or more issues stored in profile-storing module 216. In various embodiments of the present invention, the dignitaries or their authorized agents may be members of online community 300. Therefore, the dignitaries or their authorized agents have the ability to post their opinions on online community 300.

In various embodiments of the present invention, system 302 may establish commonality between members 104, as explained in detail in conjunction with FIG. 2. The participating members provide the responses by selecting one of the predefined options. Attribute-deriving module 206 processes the responses to derive the attributes of the participating members. Commonality-deriving module 208 derives a commonality indicator between at least two of the participating members based on their attributes. Further, normalcy-deriving module 210 derives a normalcy indicator of a participating member with respect to the participating members based on their attributes.

In various embodiments of the present invention, different elements of system 302, such as interface module 204, attribute-deriving module 206, commonality-deriving module 208, normalcy-deriving module 210, opinion-deriving module 304, storing module 212, or a combination thereof may be implemented in the form of hardware, software, firmware, or a combination thereof. One or more of these modules may be present on the machine of one or more of members 104, or a dedicated computational device on communication network 102.

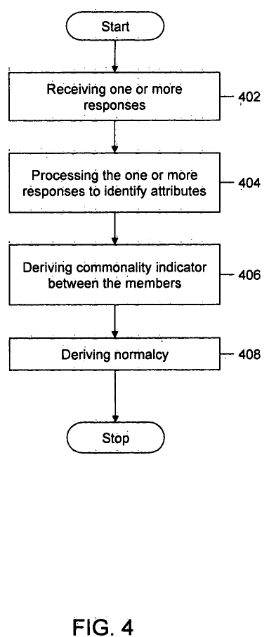

FIG. 4 depicts a flowchart of a method for establishing commonality between at least two members on one or more issues in an online community, in accordance with an embodiment of the present invention.

The online community includes a plurality of members connected with each other through a communication network. One of the members of the online community, hereinafter referred to as the questioner, poses a questionnaire which includes one or more questions, such as ‘What is your favorite pass-time?’ corresponding to an issue, such as ‘Favorite Hobby’. In various embodiments of the present invention, the questioner associates a plurality of predefined options with the questionnaire, such as ‘reading books’, ‘socializing’, ‘sports’, ‘playing video games’, ‘watching news on television’, and ‘others’.

At step 402, one or more responses are received from one or more of the plurality of members, hereinafter referred to as the participating members. The participating members select their responses from the predefined options. For example, a first member selects ‘reading books’ and a second member selects ‘sports’ from the predefined options.

In another embodiment of the present invention, a plurality of predefined comments, hereinafter referred to as the predefined comments, may be associated with each of the predefined options. For example, the questioner may associate comments such as, ‘reading enhances knowledge’ and ‘reading increases vocabulary’ with option ‘reading books’. Further, the questioner may associate comments such as, ‘playing cricket’, ‘playing soccer’, and ‘playing basketball’ with the option ‘sports’. Thus, the first member may select a comment ‘reading enhances knowledge’ and the second member may select a comment ‘playing soccer’ with their respective options.

At step 404, the responses received from the participating members are processed to identify one or more attributes associated with each of the participating members. For example, the attributes associated with the first member may include ‘active reader’ and with the second member may include ‘soccer fan’.

At step 406, a commonality indicator between the participating members is derived based on at least one of the responses to the questionnaire and the attributes derived at step 404. The commonality indicator may be a quantitative value, such as a numerical value, a percentage and a fractional number, or a qualitative value, such as ‘low’, ‘average’, ‘high’, and ‘excellent’. In an embodiment of the present invention, the commonality indicator between at least two of the participating members on an issue is derived based on their responses to each of the one or more questions on the issue. For example, two participating members who select the option ‘sports’ may have a commonality indicator of ‘high’ and another two participating members who select the option ‘sports’ and comment ‘playing basketball’ may have a commonality indicator of ‘excellent’.

In an embodiment of the present invention, the questioner associates a score with each of the predefined options in the questionnaire on an issue. The commonality indicator between at least two of the participating members on the issue is derived based on a comparison of their scores for each question in the questionnaire.

In another embodiment of the present invention, the commonality indicator between at least two of members is derived based on the attributes of the members included in their member profiles. The attributes included in the member profiles are derived based on their responses to questionnaires on various issues answered during the term their memberships.

As explained earlier in conjunction with FIG. 1 and FIG. 2, the members form one or more groups based on the registration details. Similarly, the members may form one or more groups based on their attributes derived through the questionnaires on various issues and included in the member profiles. One or more attributes of the one or more groups are derived based on the responses of the participating members of the respective groups. For example, all the participating members with the response ‘sports’ form a group of ‘Sports Fan Club’. If a majority of the options and comments received from the members of ‘Sports Fan Club’ are ‘sports’ and ‘playing soccer’ respectively, the attributes derived for the group is ‘soccer fans’. A commonality indicator between at least two groups may be derived based on their attributes.

Further, if a normalcy indictor is desired, then at step 408, the normalcy indicator is derived based on the attributes of the member and the attributes of the group. The normalcy indicator determines the degree of normalcy of the member with respect to the group. Examples of normalcy indicators may include, but are not limited to, a quantitative value, such as a numerical value and a percentage value, or a qualitative value, such as normal and abnormal. For example, the normalcy indicator of the first member with attribute ‘active reader’ and the second member with attribute ‘soccer fan’ are ‘abnormal’ and ‘normal’ respectively, with respect to the ‘Sports Fan Club’ with attribute ‘soccer fans’.

In various embodiments of the present invention, the questioner modifies at least one of the questions and the predefined options if the questionnaire or predefined options are not clear to the members. Thereafter, the process is continued at step 402.

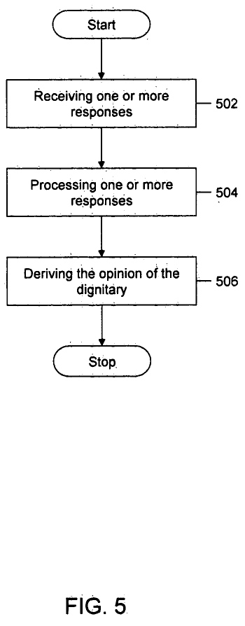

FIG. 5 depicts a flowchart of a method for deriving an opinion of a dignitary on one or more issues in an online community, in accordance with an embodiment of the present invention.

The online community includes a plurality of members connected with each other through a communication network.

One of the members of the online community, hereinafter referred to as the questioner, poses a questionnaire which includes one or more questions, such as ‘Should funds for research and development be increased?’ on one or more issues, such as ‘Research and Development in the field of Genetic Engineering’. The questioner associates a plurality of predefined options, such as ‘support’, ‘oppose’ and ‘undecided’, hereinafter referred to as the predefined options, with the questionnaire. The predefined options may be based on the various possible opinions that the dignitaries may have on the issues. In an embodiment of the present invention, the questioner associates a plurality of predefined comments, hereinafter referred to as the predefined comments, with each of the predefined options. For example, the questioner associates comments ‘strong research and development ensure a strong nation’ and ‘genetic engineering has good revenue generating potential’ with the predefined option ‘support’.

One or more of the plurality of members, hereinafter referred to as the participating members, answer the questionnaire by selecting one of the predefined options associated with a question. The participating members select options according to what they suppose to be the opinion of the dignitary. Further, the participating members may select one of the predefined comments associated with an option.

At step 502, one or more responses are received from the participating members of the online community. The participating members select such options according to what they suppose to be the opinion of the dignitary.

For example, the dignitaries may be George Bush, Arnold Schwarzenegger, Bill Clinton and Bill Gates. A first member selects ‘support’ as the response on behalf of George Bush. Further, the first member selects the comment, ‘strong research and development ensure a strong nation’ associated with the response.

At step 504, at least one of the responses is processed. At step 506, the opinion of George Bush is derived, based on the processing of the responses. In an embodiment of the present invention, if the majority of the options selected corresponding to George Bush are ‘support’ and the comments selected are ‘genetic engineering has good revenue generating potential’, the derived opinion of George Bush is ‘George Bush supports increasing funds for research in genetic engineering because of the potential of generating good revenue’. Similarly, opinions of other dignitaries may be derived based on the responses of the participating members corresponding to the dignitaries.

In various embodiments of the present invention, the questioner may modify at least one of the questions, the predefined options, and the predefined comments. The modification may be required if the number of responses received is less than the expectation of the questioner or the questioner decides to change the questions. In an embodiment of the present invention, the participating members may modify their responses. For example, the first member modifies the response from ‘support’ to ‘oppose’. In various embodiments of the present invention, the opinions derived may be modified, based on the modification in the questions, predefined options, predefined comments, and responses.

The method, system and computer program product described above have a number of advantages. The method facilitates establishing commonality between the members of the online community. The commonality, thus established, enables the members to compare their views with that of other members. Further, the method facilitates establishing normalcy of a member with respect to other members of the online community. The method provides a search interface that enables members to search for compatible members and extend their social network for collective activities. Further, the members may initiate contests, discussions and debates with other members on various issues. The members may initiate polls to decide on the winners of the contests and debates.

The method and system for deriving commonality between a plurality of members on one or more issues, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and a means for communication to other computer systems. The computer also comprises a microprocessor. The microprocessor is connected to a communication bus. The computer also includes a memory. The memory may include Random Access Memory (RAM) and Read Only Memory (ROM). The computer system also comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an 1/0 interface. The communication unit also enables the transfer as well as reception of data from other databases. The communication unit may include a modem, an Ethernet card, or any similar device, which enables the computer system to connect to databases and networks such as LAN, MAN, WAN and the Internet. The computer system facilitates inputs from a user through an input device that is accessible to the system through an I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention as described in the claims.

What is claimed is:

1. A method for establishing commonality between a plurality of members based on one or more issues in an online community, each of the one or more issues being associated with one or more questions, each of the one or more questions providing a plurality of predefined options, the method comprising:
a. receiving one or more responses corresponding to the one or more questions, the one or more responses being selected from the plurality of predefined options;
b. processing the one or more responses to derive one or more attributes corresponding to each of the plurality of members providing a response;
and
c. deriving a commonality indicator between the plurality of members providing a response on the one or more issues based on the one or more attributes.

2. The method according to claim 1 further comprising receiving one or more comments from the plurality of members, the one or more comments being associated with at least one of the plurality of predefined options.

3. The method according to claim 1 further comprising deriving a normalcy indicator of at least one of the plurality of members with respect to the plurality of members based on the one or more attributes.

4. The method according to claim 1 further comprising modifying at least one of the one or more questions, the plurality of predefined options, and the one or more responses.

5. A method for deriving an opinion of a dignitary on one or more issues in an online community, each of the one or more issues being associated with one or more questions, each of the one or more questions providing a plurality of predefined options, the online community comprising a plurality of members, the method comprising:
a. receiving one or more responses corresponding to each of the one or more questions, the one or more responses being selected from the plurality of predefined options; and
b. processing the one or more responses to derive the opinion of the dignitary.

6. The method according to claim 5 further comprising receiving one or more comments from the plurality of members, the one or more comments being associated with at least one of the plurality of predefined options.

7. The method according to claim 5 further comprising modifying at least one of the one or more questions, the plurality of predefined options, and the one or more responses.

8. A system for establishing commonality between a plurality of members based on one or more issues in an online community, the system comprising:
a. a storing module, the storing module storing one or more questions, the one or more questions being associated with the one or more issues, wherein each of the one or more questions provides a plurality of predefined options;
b. an interface module, the interface module receiving one or more responses corresponding to the one or more questions, the one or more responses being selected from the plurality of predefined options;
c. an attribute-deriving module, the attribute-deriving module processing the one or more responses to derive one or more attributes corresponding to each of the plurality of members providing a response; and
d. a commonality-deriving module, the commonality-deriving module deriving a commonality indicator between the plurality of members providing a response based on the one or more attributes.

9. The system according to claim 8, wherein the interface module further receives one or more comments from the plurality of members, the one or more comments being associated with at least one of the plurality of predefined options.

10. The system according to claim 8 further comprising a normalcy-deriving module, the normalcy-deriving module deriving a normalcy indicator of at least one of the plurality of members with respect to the plurality of members based on the one or more attributes.

11. The system according to claim 8, wherein the storing module further stores the one or more attributes associated with each of the plurality of members providing a response.

12. A system for deriving an opinion of a dignitary on one or more issues in an online community, the online community comprising a plurality of members, the system comprising:
a. a storing module, the storing module storing one or more questions, the one or more questions being associated with the one or more issues, wherein each of the one or more questions provides a plurality of predefined options;
b. an interface module, the interface module receiving one or more responses corresponding to the one or more questions, the one or more responses being selected from the plurality of predefined options, the one or more responses being attributed to the dignitary; and
c. an opinion-deriving module, the opinion-deriving module deriving the opinion of the dignitary based on the one or more responses.

13. The system according to claim 12, wherein the interface module further receives one or more comments, the one or more comments being associated with at least one of the plurality of predefined options.

14. The system according to claim 12, wherein the storing module further stores the opinion of the dignitary.

15. A computer program product for use with a computer, the computer program product comprising a computer usable medium having a computer readable program code embodied therein for establishing commonality between a plurality of members based on one or more issues in an online community, each of the one or more issues being associated with one or more questions, each of the one or more questions providing a plurality of predefined options, the computer readable program code performing the steps of:
a. receiving one or more responses corresponding to the one or more questions, the one or more responses being selected from the plurality of predefined options;
b. processing the one or more responses to derive one or more attributes corresponding to each of the plurality of members providing a response; and
c. deriving a commonality indicator between the plurality of members providing a response on the one or more issues based on the one or more attributes.

16. The computer program product according to claim 15, wherein the computer readable program code further performs the step of receiving one or more comments from the plurality of members, the one or more comments being associated with at least one of the plurality of predefined options.

17. The computer program product according to claim 15, wherein the computer readable program code further performs the step of deriving a normalcy indicator of at least one of the plurality of members with respect to the plurality of members based on the one or more attributes.

18. The computer program product according to claim 15, wherein the computer readable program code further performs the step of modifying at least one of the one or more questions, the plurality of predefined options, and the one or more responses.

19. The computer program product according to claim 15, wherein the computer readable program code further performs the step of deriving an opinion of a dignitary on one or more issues in an online community,
